(19) United States
(12) Patent Application Publication
(10) Pub. No.: US 2026/0057229 A1
(43) Pub. Date: Feb. 26, 2026

(54) METHOD, DEVICE AND STORAGE MEDIUM FOR SPEECH PROCESSING

(71) Applicants: Beijing Zitiao Network Technology Co., Ltd., Haidian District (CN); Lemon Inc., Grand Cayman (KY)

(72) Inventors: Minglun Han, Beijing (CN); Ye Bai, Beijing (CN); Chen Shen, Beijing (CN); Lu Lu, Los Angeles, CA (US)

(21) Appl. No.: 19/275,246

(22) Filed: Jul. 21, 2025

(30) Foreign Application Priority Data
Aug. 22, 2024 (CN) 202411162778.2

(51) Int. Cl. G06N 3/08; G10L 25/30

(52) U.S. Cl. CPC G06N 3/08; G10L 25/30

(57) ABSTRACT

According to an embodiment of the disclosure, a method, apparatus, device and computer-readable storage medium for speech processing are provided. The method includes: acquiring a speech feature sequence corresponding to a speech sample, the speech feature in the speech feature sequence corresponding to a speech frame in the speech sample. For the target speech feature in the speech feature sequence, one or more subsequent speech tokens respectively corresponding to the one or more subsequent speech features are generated based on the target speech feature and the one or more preceding speech features and according to the speech encoding model. A speech encoding model is trained based on the one or more subsequent speech tokens. This training approach enables the speech encoding model to learn high-quality speech representations.

### CROSS-REFERENCE TO RELATED APPLICATION

This application claims priority to Chinese Patent Application No. 202411162778.2, filed on Aug. 22, 2024, which is hereby incorporated by reference in its entirety.

### FIELD

Example embodiments of the present disclosure generally relate to the field of computers, and in particular, to a method, a device and a computer-readable storage medium for speech processing.

### BACKGROUND

With the advancement of machine learning technologies, machine learning models have been utilized to perform tasks in various application environments. Speech models are employed to process the inputted speech information (e.g., speech recognition or speech editing). To improve the performance of the speech models, it is often required to pre-train the speech models. However, current pre-training methods for the speech models present certain issues, resulting in poor performance of the speech models in some speech processing tasks or scenarios, which affects the speech processing outcomes.

### SUMMARY

In a first aspect of the present disclosure, a method for speech processing is provided. The method comprises: acquiring a speech feature sequence corresponding to a speech sample, a speech feature in the speech feature sequence corresponding to a speech frame in the speech sample; generating, for a target speech feature in the speech feature sequence, based on the target speech feature and one or more preceding speech features and according to a speech encoding model, one or more subsequent speech tokens respectively corresponding to one or more subsequent speech features, the one or more preceding speech features indicating speech features in the speech feature sequence that are prior to the target speech feature, and the one or more subsequent speech features indicating speech features in the speech feature sequence that are after the target speech feature; and training the speech encoding model based on the one or more subsequent speech tokens.

In a second aspect of the present disclosure, an apparatus for speech processing is provided. The apparatus comprises: an acquiring module configured to acquire a speech feature sequence corresponding to a speech sample, a speech feature in the speech feature sequence corresponding to a speech frame in the speech sample; a generating module configured to generate, for a target speech feature in the speech feature sequence, based on the target speech feature and one or more preceding speech features and according to a speech encoding model, one or more subsequent speech tokens respectively corresponding to one or more subsequent speech features, the one or more preceding speech features indicating speech features in the speech feature sequence that are prior to the target speech feature, and the one or more subsequent speech features indicating speech features in the speech feature sequence that are after the target speech feature; and a training module configured to train the speech encoding model based on the one or more subsequent speech tokens.

In a third aspect of the present disclosure, an electronic device is provided. The device comprises at least one processor; and at least one memory coupled to the at least one processor and storing instructions for execution by the at least one processor. The instructions, when are executed by the at least one processor, cause the device to perform the method of the first aspect.

In a fourth aspect of the present disclosure, a computer-readable storage medium is provided. The computer-readable storage medium stores thereon a computer program executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates an architectural diagram of an example of a model training system according to some embodiments of the present disclosure;

FIG. 3 illustrates an architectural diagram of another example of a model training system according to some embodiments of the present disclosure;

FIG. 4 shows a flowchart of a speech processing procedure according to some embodiments of the present disclosure;

FIG. 5 shows a block diagram of an apparatus for speech processing according to some embodiments of the present disclosure; and

FIG. 6 illustrates a block diagram of a device capable of implementing various embodiments of the present disclosure.

### DETAILED DESCRIPTION

It can be understood that prior to implementing the technical solutions disclosed in various embodiments of the present disclosure, the types of personal information, the usage scope, the usage scenario and the like involved in the present disclosure should be notified to the users and their authorization should be obtained in an appropriate manner in compliance with the relevant laws and regulations.

For example, in response to receiving an active request from a user, prompt information should be sent to the user to explicitly prompt the user that the requested operation will require the acquisition and use of the personal information of the user, thereby enabling the user to autonomously select whether to provide personal information to software or hardware that executes the operations of the technical solution of the present disclosure, according to the prompt information.

As an optional but non-limiting implementation, in response to receiving the active request of the user, the manner of sending the prompt information to the user may be, for example, a pop-up window, in which the prompt information may be presented in a text manner. In addition, the pop-up window may further carry a selection control for the user to select “agree” or “disagree” to provide personal information to the electronic device.

It can be understood that the aforementioned notification and user authorization acquisition procedures are merely illustrative, and should not be construed as a limitation on implementations of the present disclosure, and other manners compliant with relevant laws and regulations may also be applied to implementations of the present disclosure.

It can be understood that the data involved in the technical solution (including but not limited to the data itself, and the acquisition or use of the data) should comply with the requirements of the applicable laws, regulations and relevant rules.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure serve only exemplary purposes and are not intended to limit the scope of protection of the present disclosure.

It should be noted that the any section/subsection headings provided herein are non-limiting. Various embodiments are described throughout and any type of embodiments may be included in any section/subsection. Furthermore, the embodiments described in any section/subsection may be combined in any manner with any other embodiments described within the same section/subsection and/or different sections/subsections.

Herein, unless explicitly stated, performing a step “in response to A” does not imply that this step is performed immediately after “A”, and one or more intermediate steps may be included.

In the description of the embodiments of the present disclosure, the term “comprising/including” and similar expressions should be understood as open-ended inclusion, i.e., “including but not limited to”. The term “based on” should be understood as “at least partially based on”. The terms “one embodiment” or “the embodiment” should be understood as “at least one embodiment”. The term “some embodiments” should be understood as “at least some embodiments”. Other explicit and implicit definitions may also be included below. The terms “first,” “second,” etc. may refer to different or identical objects. Other explicit and implicit definitions may also be included below.

As used herein, the term “model” may learn correlations between respective inputs and outputs from training data such that corresponding outputs may be generated for given inputs after training is completed. The generation of the model may be based on machine learning techniques. Deep learning is a machine learning algorithm that processes inputs and provides corresponding outputs by using a multi-layer processing unit. A “model” may also be referred to herein as a “machine learning model,” a “machine learning network,” or a “network,” which terms are used interchangeably herein. A model may in turn include different types of processing units or networks.

As used herein, a “unit,” an “operating unit,” or a “sub-unit” may be composed of any suitably structured machine learning model or network. As used herein, a set of elements or similar expressions may include one or more such elements. For example, “a set of convolution units” may include one or more convolution units.

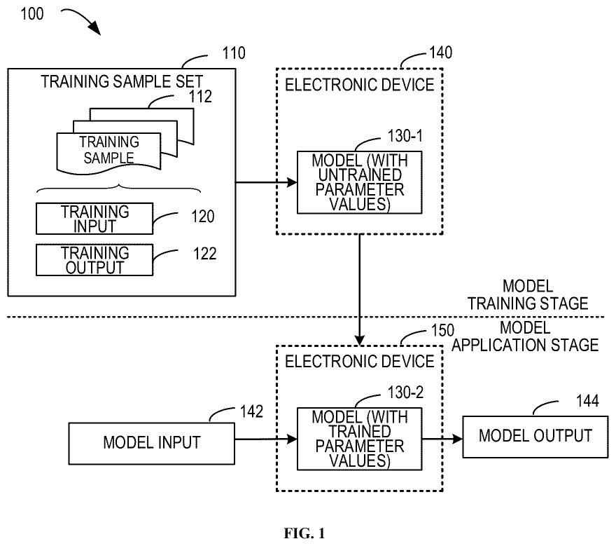

FIG. 1 illustrates a schematic diagram of an example environment 100 in which embodiments of the present disclosure can be implemented. As shown in FIG. 1, a model 130-1 with untrained parameter values and a model 130-2 with trained parameter values may be collectively or individually referred to as a model 130. The model 130 may be implemented or included in the electronic device 140 and/or the electronic device 150.

In the environment 100 of FIG. 1, it is desirable to train and use such a machine learning model (i.e., model 130) that is configured for various application environments. For example, in a situation where the model is a speech recognition model, it may generate text corresponding to speech based on user-input speech to be processed.

As shown in FIG. 1, the environment 100 includes an electronic device 140 and an electronic device 150. There may be a speech processing system in the electronic device 140, and there may be a model application system in the electronic device 150. The upper part of FIG. 1 shows the process of the model training stage, and the lower part shows the process of the model application stage. Before training, the parameter values of the model 130 may have initial values, or may have pre-trained parameter values obtained through a pre-training process. The model 130-1 may be trained via forward propagation and backward propagation, and during the training the parameter values of the model 130-1 may be updated and adjusted. Upon completion of the training, the model 130-2 may be obtained. The training of the model may further include pre-training and fine-tuning. With pre-training, the model 130-1 has a generalization capability, such as a capability of characterizing speech. Then, in the fine-tuning stage, fine-tuning is performed on the pre-trained model 130-1 for the downstream speech processing task. At this time, the parameter values of the model 130-2 have been updated, and based on the updated parameter values, the model 130-2 may be used in the model application stage to implement speech processing tasks, such as speech recognition tasks.

In the fine-tuning stage of model training, the model 130 may be trained with a model training system based on a training sample set 110 including a plurality of training samples 112. Here, each training sample 112 may be in a tuple format. For example, for a speech recognition task, training samples 112 may include training inputs 120 and training outputs in the speech recognition task. The training inputs in the speech recognition task may include, for example, training audios and texts corresponding to the training audios. The training samples 112 including the model inputs 120 and the model outputs 122 may be used to train model 130. Specifically, the training process may be iteratively performed by using a large number of training samples. After training is completed, the model 130 may include knowledge about the task to be processed. In the model application stage, the model 130 (having the trained parameter values at this time) may be used to perform corresponding tasks. For example, model inputs 142 in a speech recognition task may be received and corresponding model outputs 144 may be output.

In FIG. 1, the electronic device 140 and the electronic device 150 may include any computing system with computing capabilities, such as various computing devices/systems, terminal devices, servers, and the like. The terminal devices may relate to any type of mobile terminals, fixed terminals, or portable terminals, including mobile phones, desktop computers, laptop computers, notebook computers, netbook computers, tablet computers, media computers, multimedia tablets, or any combination thereof, along with accessories and peripherals of these devices or any combination thereof. The servers include, but are not limited to, mainframes, edge computing nodes, computing devices in cloud environments, and the like.

It should be understood that the components and arrangements in the environment 100 shown in FIG. 1 are merely examples, and that the computing system suitable for implementing the exemplary implementations described in this disclosure may include one or more different components, other components, and/or different arrangements. Implementations of the present disclosure are not limited in this respect.

As briefly mentioned above, the speech model is used for processing user-input speech information. In various speech processing tasks or scenarios, speech needs to be encoded and characterized according to a speech model.

In some speech processing scenarios, for example, in streaming speech processing, a speech model with causality is required. Traditionally, speech models are mainly trained through a speech self-supervised technique based on a masked prediction mechanism. This training approach requires utilizing contextual content of the input speech for prediction. The speech models obtained in this approach lack causality, and thus have poor performance on tasks such as streaming speech processing. Therefore, it is desirable to obtain a speech model with causality in the pre-training stage. Such a speech model with causality can be used for streaming speech recognition, such as streaming speech recognition.

To this end, a solution for speech processing is provided in embodiments of the present disclosure. According to various embodiments of the present disclosure, a speech feature sequence corresponding to a speech sample is acquired, and a speech feature in the speech feature sequence corresponds to a speech frame in the speech sample. For a target speech feature in the speech feature sequence, one or more subsequent speech tokens respectively corresponding to one or more subsequent speech features are generated based on the target speech feature and the one or more preceding speech features and according to a speech encoding model. The one or more preceding speech features indicate speech features in the speech feature sequence that are prior to the target speech feature, and the one or more subsequent speech features indicate speech features in the speech feature sequence that are after the target speech feature. A speech encoding model is trained based on the one or more subsequent speech tokens.

The subsequent speech tokens corresponding to the subsequent speech features for the target speech feature are determined based on the target speech feature and the preceding speech features corresponding to the target speech feature. This training approach enables the speech encoding model to learn high-quality speech representations. Such a speech encoding model can be used for various speech processing tasks, particularly streaming speech processing tasks.

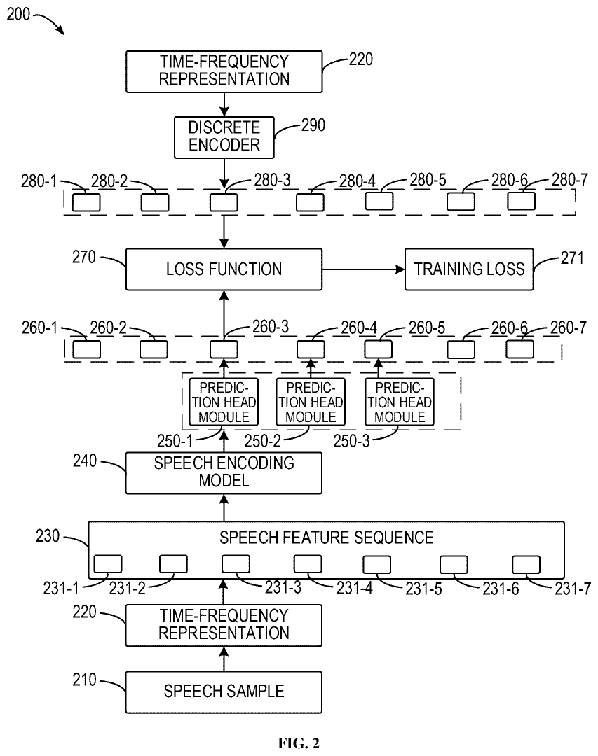

FIG. 2 illustrates an architectural diagram of an example of a model training system according to some embodiments of the present disclosure. As shown in FIG. 2, the model training system may be implemented in or included in the electronic device 140. The electronic device 140 is configured to train a speech encoding model 240 based on the speech samples 210 provided by the user to update parameters of the speech encoding model 240.

In some embodiments, the speech samples 210 are speech data containing human vocal track information, and the speech samples 210 are used to train the speech encoding model 240. The speech data may be existing data including both human vocal track information and reverberation in the Internet, or speech data including only human vocal track information recorded in a high-standard recording environment.

If the speech data is data obtained from the Internet that includes reverberation and human vocal track information, it is necessary to extract the speech samples 210 (that is, the human vocal track information) from the speech data. In some embodiments, the speech data may be separated by using a sound source separating module to acquire human vocal track information from the music data. The music samples may include a plurality of human vocal track speech signals.

In some embodiments, the electronic device 140 acquires a speech feature sequence 230 corresponding to a speech sample 210. The speech feature sequence 230 includes a plurality of speech features, and the speech features respectively correspond to a plurality of speech frames in the speech sample 210. In some embodiments, the speech frame indicates a segment of speech signal in the speech sample 210.

In some embodiments, the speech sample 210 may be a time-domain signal. After acquiring the speech sample 210, the electronic device 140 first determines a time-frequency representation 220 corresponding to the speech sample 210. Then, a sampling operation is performed on the obtained time-frequency representation 220 to generate the speech feature sequence 230. The speech feature sequence 230 includes speech features respectively corresponding to the plurality of speech frames. As shown in FIG. 2, the speech feature sequence 230 includes at least a first speech feature 231-1, a second speech feature 231-2, a third speech feature 231-3, a fourth speech feature 231-4, a fifth speech feature 231-5, a sixth speech feature 231-6, a seventh speech feature 231-7, and the like, which may be individually or collectively referred to as a speech feature 231. It should be noted that the number of speech features 231 shown in FIG. 2 is for illustration. The speech feature sequence 230 may include any suitable number of speech features. Embodiments of the present disclosure are not limited in this respect. The time-frequency representation 220 at least indicates an intensity of the speech sample 210 over time at different frequencies. For example, the time-frequency representation 220 corresponding to the speech sample 210 may be determined by using a signal processing method (for example, Mel-frequency cepstral coefficients).

In some embodiments, the sampling rate of the time-frequency representation 220 may be reduced to decrease data amount and computational complexity. The speech feature sequence 230 is generated by down-sampling. For example, for a speech sample S, after the speech sample S being processed by a time-frequency conversion operation, a time-frequency representation including T speech frames X=(x₁, x₂, x₃, x₄, . . . , x_{T}) corresponding to the speech sample S may be acquired. Then, the time-frequency representation 220 of the speech sample S is down-sampled to obtain a speech feature sequence I=(i₁, i₂, i₃, i₄, . . . , i_{L}) of a length L. The length L of the speech feature sequence I is determined by the down-sampling rate, and the length L is not greater than the length T of the time-frequency representation 220.

For a target speech feature in the speech feature sequence 230, the electronic device 140 generates one or more subsequent speech tokens respectively corresponding to one or more subsequent speech features, based on the target speech feature and one or more preceding speech features and according to the speech encoding model 240. The one or more preceding speech features indicate speech features in the speech feature sequence 230 that are prior to the target speech feature, and the one or more subsequent speech features indicate speech features in the speech feature sequence 230 that are after the target speech feature.

In some embodiments, the speech feature sequence 230 corresponding to the speech frames in the speech sample 210 that is acquired by the electronic device 140 is provided to the speech encoding model 240 for training of the speech encoding model 240. In some embodiments, the complete speech feature sequence 230 may be input into the speech encoding model 240, or the speech feature sequence 230 containing only speech features corresponding to partial speech frames may be input into the speech encoding model 240 to achieve the effects of down-sampling.

The target speech feature may be any of the speech features in the speech feature sequence 230. Still taking streaming speech processing as an example, in a scenario of streaming speech processing (for example, streaming speech recognition), if a certain speech frame needs to be processed, the speech encoding model can only encode preceding speech frames. Therefore, there is a need for the speech encoding model to have causality. The pre-trained speech encoding model according to the embodiments of the present disclosure has such causality, making it adaptable to downstream streaming speech processing tasks, such as streaming speech recognition tasks. This training approach enables the speech encoding model to learn high-quality speech representations.

In some embodiments, in the processing of the speech feature sequence 230 according to the speech encoding model 240, the position of the target speech feature in the speech feature sequence 230 is first determined. The preceding speech features with positions prior to the target speech feature are determined based on relative positions of the speech features in the speech feature sequence 230. In some embodiments, for determination of the target speech feature, the speech features corresponding to all speech frames in the speech sample 210 may first be determined, thereby constructing the speech feature sequence 230. The target speech feature is determined from the constructed speech feature sequence 230. Alternatively or additionally, the target speech frame may be first determined, and then the target feature sequence corresponding to the target speech frame may be determined. The preceding speech frames and the subsequent speech frames are determined based on the relative positions of the other speech frames to the target speech frame. Then, the preceding speech features and the subsequent speech features respectively corresponding to the preceding speech frames and the subsequent speech frames are determined.

In some embodiments, the number of the preceding speech features may be one or more. When the target speech feature is encoded to obtain an encoded representation corresponding to the target speech feature, the encoding may be performed on the basis of all preceding speech features of the target speech feature, or on the basis of a portion of the preceding speech features. For example, the encoded representation corresponding to the target speech feature may be obtained based on the P preceding speech features that are closest to the target speech feature, where P is a positive integer. In this way, when the speech encoding model is used for a downstream speech processing task, computing resources can be saved.

In some embodiments, the electronic device 140 generates a training sequence based on the obtained preceding speech features and the target speech feature. The training sequence is provided to the speech encoding model 240 to acquire the encoded speech representation generated by the speech encoding model 240. The encoded speech representation output by the speech encoding model 240 is processed by using prediction head modules to generate subsequent speech tokens (discrete tokens). The number of prediction head modules is consistent with the number of generated subsequent speech features. The model parameters of the prediction head modules may be updated during training of the speech encoding model 240. As shown in FIG. 2, the prediction head modules include a prediction head module 250-1, a prediction head module 250-2, a prediction head module 250-3, which may be individually or collectively referred to as a prediction head module 250. In some embodiments, the prediction head modules 250 with different parameters are utilized to process the encoded speech representations corresponding to different target speech features. For example, the prediction head module 250 may include a softmax head and any other suitable processing layers (e.g., a mapping layer).

In some embodiments, the number of the subsequent speech features may be one or more, and correspondingly, the number of the predicted subsequent speech tokens may be one or more. In the process of encoding and predicting the subsequent speech tokens corresponding to the subsequent speech features according to the speech encoding model 240, because a speech signal possesses continuity and stationarity and does not change drastically within a short period of time, it is possible for the speech feature of the speech frame that is one frame later to have a high similarity to the speech feature of the current speech frame. In such a case, if only the speech token of the speech frame that is one frame later is predicted, the self-supervised learning task for speech becomes overly simple, so that the speech encoding model cannot learn high-quality speech representations. In consideration of the short-term stationarity of a speech signal at the microscopic level, in some embodiments, for each speech frame, speech tokens of a plurality of subsequent speech frames are predicted, so that the model can learn high-quality speech representations.

One example is described with reference to FIG. 2. FIG. 2 illustrates a first speech token 260-1, a second speech token 260-2, a third speech token 260-3, a fourth speech token 260-4, a fifth speech token 260-5, a sixth speech token 260-6, and a seventh speech token 260-7, etc., which may be individually or collectively referred to as a speech token 260. It should be noted that the number of the speech tokens 260 in FIG. 2 is for illustration, and the number of the speech tokens included in the speech token sequence 260 is not limited herein. For example, if the speech feature 231-2 in the speech feature sequence 230 is determined as the target speech feature, the preceding speech feature is the first speech feature 231-1. The subsequent speech features are the third speech feature 231-3 and the fourth speech feature 231-4. The speech encoding model 240 generates the encoded speech representation corresponding to the second speech feature 231-2 based on the first speech feature 231-1 and the second speech feature 231-2. The encoding representation corresponding to the second speech feature 231-2 is provided to the prediction head modules 250-1, 250-2, 250-3 to generate the subsequent speech tokens 260-3 (corresponding to the third speech feature 231-3), 260-4 (corresponding to the fourth speech feature 231-4), 260-5 (corresponding to the fourth speech feature 231-5). That is, in this example, three subsequent speech tokens are predicted for a certain speech feature. However, it should be understood that this is merely exemplary, and in embodiments of the present disclosure, the number of predicted subsequent speech tokens is not limited.

In some embodiments, the electronic device 140 trains the speech encoding model 240 based on the one or more subsequent speech tokens.

In some embodiments, the electronic device 140 encodes the speech sample 210 with a discrete encoder 290 to generate reference speech tokens 280 respectively corresponding to each subsequent speech feature. The parameters of the discrete encoder 290 may be pre-trained, or the parameters of the encoder may be updated in the process of training the speech encoder. For example, the time-frequency representation 220 corresponding to the speech sample 210 is first determined. The speech encoder generates reference speech tokens 280 based on the time-frequency representation 220. As shown in FIG. 2, the reference speech tokens include a first reference speech token 280-1, a second reference speech token 280-2, a third reference speech token 280-3, a fourth reference speech token 280-4, a fifth reference speech token 280-5, a sixth reference speech token 280-6, and a seventh reference speech token 280-7, etc., which may be individually or collectively referred to as a reference speech token 280. It should be noted that the number of the reference speech tokens 280 in FIG. 2 is illustrative, and the number of the speech features included in the reference speech tokens 280 is not limited herein.

In some embodiments, the electronic device 140 determines training loss components by comparing the one or more subsequent speech tokens and the one or more reference speech tokens 280. The model parameters of the speech encoding model 240 are updated based on the training loss components.

In some embodiments, the training loss components are a training loss 271 determined based on differences between reference speech tokens 280 and subsequent speech tokens generated for the speech feature sequence 230 of a speech frame in a speech sample 210. For example, for each subsequent speech token, a subsequent speech feature corresponding the subsequent speech token is determined, and then a reference speech token 280 corresponding to the subsequent speech feature is determined. The difference between each subsequent speech token and its corresponding reference speech token 280 is then taken as the training loss component.

In some embodiments, since a down-sampling unit is typically provided in the discrete encoder 290, the sequence length of the speech token sequence (that is, the number of speech tokens) generated by the speech encoding model 240 may differ from the sequence length of the reference speech token sequence (that is, the number of the reference speech tokens 280). Therefore, the sequence length of the reference speech token sequence or the sequence length of the speech token sequence generated by the speech encoding model 240 may be adjusted to ensure consistency between their lengths. For example, if the sequence length of the reference speech token sequence is adjusted, sequence length information of the corresponding subsequent speech tokens is first determined. The sequence length of the reference speech token 280 is adjusted based on the obtained sequence length information.

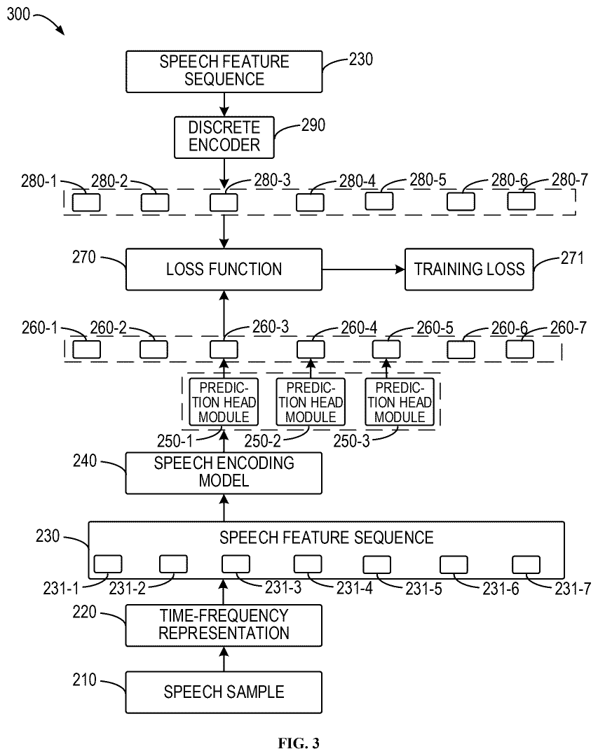

FIG. 3 illustrates an architectural diagram of another example of a model training system according to some embodiments of the present disclosure. As shown in FIG. 3, the discrete encoder 290 may generate the reference speech tokens 280 based on the speech feature sequence 230, thereby ensuring consistency between the sequence length of the reference speech token sequence and the sequence length of the speech token sequence generated by the speech encoding model 240. The speech encoding model 240 is trained based on differences between one or more subsequent speech tokens and one or more reference speech tokens 280. In such embodiments, no additional adjustment of the sequence length of the reference speech tokens 280 is required.

Returning to FIG. 2, the electronic device 140 determines a training loss 271 corresponding to the speech feature sequence 230 (that is, the speech sample 210) based on a sum of training loss components corresponding to the subsequent speech tokens in the speech feature sequence 230. For example, the position of the target speech feature in the speech feature sequence 230 is 1. N subsequent speech tokens generated by the speech encoding model 240 is {kₗ₊₁, kₗ₊₂, kₗ₊₃, kₗ₊₄, . . . , kₗ₊ₙ}. The calculation formula for the training loss component [symbol] at the position l is as follows:

$${ℒ}_{l} = {\sum }_{n = 1}^{N} {ℒ}_{l , n} \qquad ( 1 )$$

$${ℒ}_{l , n} = - log {P}_{θ} ( {k}_{l + n} \vert {i}_{1 : l} ) \qquad ( 2 )$$

where θ represents a parameter of the speech encoding model 240.

A calculation formula for training loss [symbol] of the speech sample 210 is as follows:

$$ℒ = {\sum }_{l = 1}^{L} {\sum }_{n = 1}^{N} {ℒ}_{l , n} \qquad ( 3 )$$

The electronic device 140 updates model parameters of the speech encoding model 240 based on the obtained training loss 271. In some embodiments, the electronic device 140 may update the model parameters of the speech encoding model 240 based on the training losses 271 respectively corresponding to a plurality of speech samples 210.

This training approach enables the speech encoding model to learn high-quality speech representations. Such a speech encoding model can be used for various speech processing tasks, particularly streaming speech processing tasks.

In some embodiments, the speech encoding model 240 may be supervised and fine-tuned by using the model training system shown in FIG. 2 based on parameters of the trained speech encoding model 240 and high-quality reference audio. As such, the performance of the speech encoding model 240 is further improved. Compared with the self-supervised training approaches, the structure of the model training system or speech encoding model 240 need not be changed. At the same time, because the model-training system is unsupervised, no text labels are required, thereby reducing the labor cost during the training process.

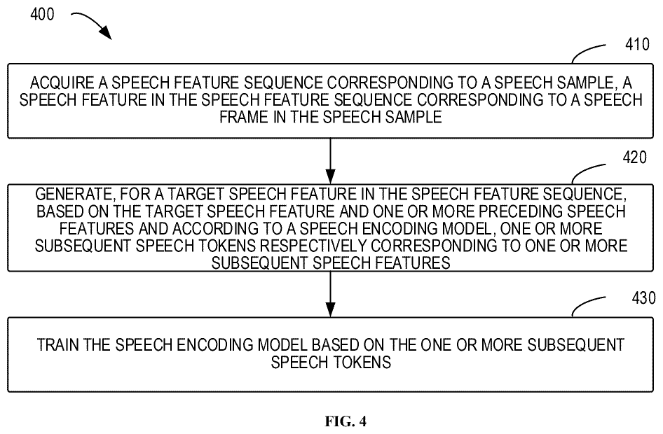

FIG. 4 shows a flowchart of a speech processing procedure 400 according to some embodiments of the present disclosure. Procedure 400 may be implemented at the electronic device 140.

At block 410, a speech feature sequence corresponding to a speech sample is acquired, and a speech feature in the speech feature sequence corresponds to a speech frame in the speech sample.

In some embodiments, the acquiring of the speech feature sequence corresponding to the speech sample includes: determining a time-frequency representation corresponding to the speech sample, the time-frequency representation at least indicating an intensity of the speech sample over time at different frequencies; and generating the speech feature sequence by down-sampling the time-frequency representation.

At block 420, for a target speech feature in the speech feature sequence, one or more subsequent speech tokens respectively corresponding to the one or more subsequent speech features are generated based on the target speech feature and one or more preceding speech features and according to a speech encoding model, the one or more preceding speech features include speech features in the speech feature sequence that are prior to the target speech feature, and the one or more subsequent speech features include speech features in the speech feature sequence that are after the target speech feature.

In some embodiments, the generating of the subsequent speech tokens respectively corresponding to the one or more subsequent speech features includes: generating, based on the target speech feature and the one or more preceding speech features and according to the speech encoding model, a encoded speech representation; and generating, based on the encoded speech representation, one or more subsequent speech tokens.

In some embodiments, the generating of the speech encoding representation according to the speech encoding model includes: generating a training sequence based on the target speech feature and the one or more preceding speech features; and generating, based on the training sequence and according to the speech encoding model, the encoded speech representation.

At block 430, the speech encoding model is trained based on the one or more subsequent speech tokens.

In some embodiments, the training of the speech encoding model based on the one or more subsequent speech tokens includes: encoding the speech sample with a discrete encoder to generate one or more reference speech tokens respectively corresponding to the one or more subsequent speech features; determining training loss components by comparing the one or more subsequent speech tokens and the one or more reference speech tokens; and updating model parameters of the speech encoding model based on the training loss components.

In some embodiments, the determining of the training loss component includes: for a given subsequent speech token in the one or more subsequent speech tokens, determining a given reference speech token corresponding to the given subsequent speech token from the one or more reference speech tokens; and determining, based on a difference between the given subsequent speech token and the given reference speech token, a training loss component corresponding to the given subsequent speech token.

In some embodiments, the procedure 400 further includes: determining sequence length information of a speech token sequence corresponding to the speech feature sequence obtained with the speech encoding model; and adjusting, based on the sequence length information, a sequence length of a reference speech token sequence corresponding to the speech feature sequence, the reference speech token being obtained with the discrete encoder, wherein the adjusted reference speech token sequence includes the one or more reference speech tokens.

In some embodiments, the training loss components are obtained with a plurality of speech features in the speech feature sequence being taken as the target speech feature respectively, and the updating of the model parameter of the speech encoding model based on the training loss components includes: determining a training loss based on a sum of the training loss components obtained for the plurality of speech features respectively; and updating the model parameters of the speech encoding model based on the training loss.

In some embodiments, the training of the speech encoding model based on the one or more subsequent speech tokens includes: encoding, with a trained discrete encoder, the speech feature sequence to generate the one or more reference speech tokens respectively corresponding to the one or more subsequent speech features; and training the speech encoding model based on a difference between the one or more subsequent speech tokens and the one or more reference speech tokens.

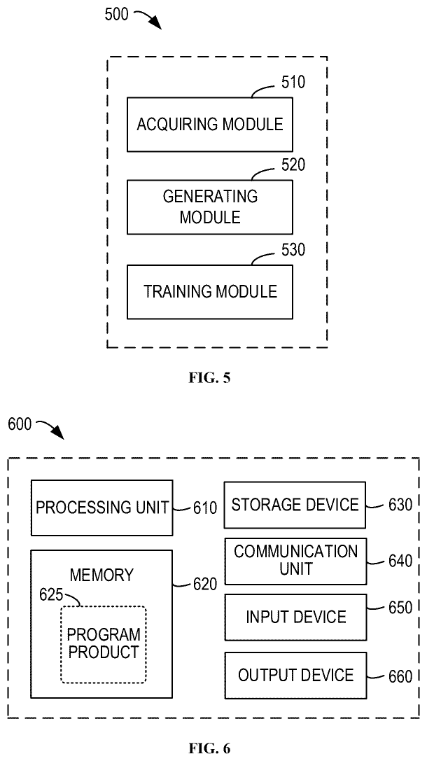

FIG. 5 shows a schematic structural block diagram of an apparatus 500 for speech processing according to some embodiments of the present disclosure. The apparatus 500 may be implemented in or included in an electronic device. The various modules/components in the apparatus 500 may be implemented by hardware, software, firmware, or any combination thereof.

As shown in FIG. 5, the apparatus 500 includes an acquiring module 510 configured to acquire a speech feature sequence corresponding to a speech sample, and a speech feature in the speech feature sequence corresponds to a speech frame in the speech sample. The apparatus 500 further includes a generating module 520 configured to generate, for a target speech feature in the speech feature sequence, based on the target speech feature and one or more preceding speech features and according to a speech encoding model, one or more subsequent speech tokens respectively corresponding to one or more subsequent speech features, the one or more preceding speech features indicating speech features in the speech feature sequence that are prior to the target speech feature, and the one or more subsequent speech features indicating speech features in the speech feature sequence that are after the target speech feature. The apparatus 500 further includes a training module 530 configured to train the speech encoding model based on the one or more subsequent speech tokens.

In some embodiments, the acquiring module 510 is further configured to determine a time-frequency representation corresponding to the speech sample, the time-frequency representation at least indicating an intensity of the speech sample over time at different frequencies; and generate a speech feature sequence by down-sampling the time-frequency representation.

In some embodiments, the generating module 520 is further configured to generate, based on the target speech feature and the one or more preceding speech features and according to the speech encoding model, an encoded speech representation; and generate, based on the encoded speech representation, the one or more subsequent speech tokens.

In some embodiments, the generating module 520 is further configured to generate a training sequence based on the target speech feature and the one or more preceding speech features; and generate, based on the training sequence and according to the speech encoding model, the encoded speech representation.

In some embodiments, the training module 530 is further configured to encode the speech sample with a discrete encoder to generate one or more reference speech tokens respectively corresponding to the one or more subsequent speech features; determine training loss components by comparing the one or more subsequent speech tokens and the one or more reference speech tokens; and update model parameters of the speech encoding model based on the training loss components.

In some embodiments, the training module 530 is further configured to determine, for a given subsequent speech token in the one or more subsequent speech tokens, a given reference speech token corresponding to the given subsequent speech token from the one or more reference speech tokens; and determine, based on a difference between the given subsequent speech token and the given reference speech token, a training loss component corresponding to the given subsequent speech token.

In some embodiments, the apparatus 500 further includes an adjusting module configured to: determine sequence length information of a speech token sequence corresponding to the speech feature sequence obtained with the speech encoding model; and adjust, based on the sequence length information, a sequence length of a reference speech token sequence corresponding to the speech feature sequence, the reference speech token being obtained with the discrete encoder, wherein the adjusted reference speech token sequence includes one or more reference speech tokens.

In some embodiments, the training module 530 is further configured to acquire training loss components with a plurality of speech features in the speech feature sequence being taken as the target speech feature, and the updating of the model parameter of the speech encoding model based on the training loss components includes: determining a training loss based on a sum of the training loss components obtained for the plurality of speech features respectively; and updating the model parameters of the speech encoding model based on the training loss.

In some embodiments, the training module 530 is further configured to encode, with a trained discrete encoder, the speech feature sequence to generate the one or more reference speech tokens respectively corresponding to the one or more subsequent speech features; and train the speech encoding model based on a difference between the one or more subsequent speech tokens and the one or more reference speech tokens.

FIG. 6 shows a block diagram illustrating an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be configured to implement the electronic device 140 and the electronic device 150 in FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing units 610 may be actual or virtual processors and capable of performing various processes according to programs stored in the memory 620. In multiprocessor systems, multiple processing units execute computer-executable instructions in parallel to improve parallel processing capabilities of electronic device 600.

The electronic device 600 typically includes a plurality of computer storage media. Such media may be any available media accessible to the electronic device 600, including but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 enables communication with another electronic devices through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having stored thereon computer-executable instructions that, when executed by a processor, implement the methods described above. According to example implementations of the present disclosure, there is further provided a computer program product tangibly stored on a non-transitory computer-readable medium and including computer-executable instructions that, when executed by a processor, implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special-purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for speech processing, comprising:
acquiring a speech feature sequence corresponding to a speech sample, a speech feature in the speech feature sequence corresponding to a speech frame in the speech sample;
generating, for a target speech feature in the speech feature sequence, based on the target speech feature and one or more preceding speech features and according to a speech encoding model, one or more subsequent speech tokens respectively corresponding to one or more subsequent speech features, the one or more preceding speech features comprising speech features in the speech feature sequence that are prior to the target speech feature, and the one or more subsequent speech features comprising speech features in the speech feature sequence that are after the target speech feature; and
training the speech encoding model based on the one or more subsequent speech tokens.

2. The method of claim 1, wherein generating the subsequent speech tokens respectively corresponding to the one or more subsequent speech features comprises:
generating, based on the target speech feature and the one or more preceding speech features and according to the speech encoding model, an encoded speech representation; and
generating, based on the encoded speech representation, the one or more subsequent speech tokens.

3. The method of claim 2, wherein generating the encoded speech representation according to the speech encoding model comprises:
generating a training sequence based on the target speech feature and the one or more preceding speech features; and
generating, based on the training sequence and according to the speech encoding model, the encoded speech representation.

4. The method of claim 1, wherein training the speech encoding model based on the one or more subsequent speech tokens comprises:
encoding the speech sample with a discrete encoder to generate one or more reference speech tokens respectively corresponding to the one or more subsequent speech features;
determining training loss components by comparing the one or more subsequent speech tokens and the one or more reference speech tokens; and
updating model parameters of the speech encoding model based on the training loss components.

5. The method of claim 4, wherein determining the training loss components comprises:
determining, for a given subsequent speech token in the one or more subsequent speech tokens, a given reference speech token corresponding to the given subsequent speech token from the one or more reference speech tokens; and
determining, based on a difference between the given subsequent speech token and the given reference speech token, a training loss component corresponding to the given subsequent speech token.

6. The method of claim 4, wherein the training loss components are obtained with a plurality of speech features in the speech feature sequence being taken as the target speech feature respectively, and updating the model parameters of the speech encoding model based on the training loss components comprises:
determining a training loss based on a sum of the training loss components obtained for the plurality of speech features respectively; and
updating the model parameters of the speech encoding model based on the training loss.

7. The method of claim 4, further comprising:
determining sequence length information of a speech token sequence corresponding to the speech feature sequence obtained with the speech encoding model; and
adjusting, based on the sequence length information, a sequence length of a reference speech token sequence corresponding to the speech feature sequence, the reference speech token being obtained with the discrete encoder, wherein the adjusted reference speech token sequence comprises the one or more reference speech tokens.

8. The method of claim 1, wherein acquiring the speech feature sequence corresponding to the speech sample comprises:
determining a time-frequency representation corresponding to the speech sample, the time-frequency representation at least indicating an intensity of the speech sample over time at different frequencies; and
generating the speech feature sequence by down-sampling the time-frequency representation.

9. The method of claim 1, wherein training the speech encoding model based on the one or more subsequent speech tokens comprises:
encoding, with a trained discrete encoder, the speech feature sequence to generate the one or more reference speech tokens respectively corresponding to the one or more subsequent speech features; and
training the speech encoding model based on a difference between the one or more subsequent speech tokens and the one or more reference speech tokens.

10. An electronic device, comprising:
at least one processor; and
at least one memory coupled to the at least one processor and storing instructions for execution by the at least one processor, the instructions, when being executed by the at least one processor, causing the electronic device to perform acts comprising:
acquiring a speech feature sequence corresponding to a speech sample, a speech feature in the speech feature sequence corresponding to a speech frame in the speech sample;
generating, for a target speech feature in the speech feature sequence, based on the target speech feature and one or more preceding speech features and according to a speech encoding model, one or more subsequent speech tokens respectively corresponding to one or more subsequent speech features, the one or more preceding speech features comprising speech features in the speech feature sequence that are prior to the target speech feature, and the one or more subsequent speech features comprising speech features in the speech feature sequence that are after the target speech feature; and
training the speech encoding model based on the one or more subsequent speech tokens.

11. The electronic device of claim 10, wherein generating the subsequent speech tokens respectively corresponding to the one or more subsequent speech features comprises:
generating, based on the target speech feature and the one or more preceding speech features and according to the speech encoding model, an encoded speech representation; and
generating, based on the encoded speech representation, the one or more subsequent speech tokens.

12. The electronic device of claim 11, wherein generating the encoded speech representation according to the speech encoding model comprises:
generating a training sequence based on the target speech feature and the one or more preceding speech features; and
generating, based on the training sequence and according to the speech encoding model, the encoded speech representation.

13. The electronic device of claim 10, wherein training the speech encoding model based on the one or more subsequent speech tokens comprises:
encoding the speech sample with a discrete encoder to generate one or more reference speech tokens respectively corresponding to the one or more subsequent speech features;
determining training loss components by comparing the one or more subsequent speech tokens and the one or more reference speech tokens; and
updating model parameters of the speech encoding model based on the training loss components.

14. The electronic device of claim 13, wherein determining the training loss components comprises:
determining, for a given subsequent speech token in the one or more subsequent speech tokens, a given reference speech token corresponding to the given subsequent speech token from the one or more reference speech tokens; and
determining, based on a difference between the given subsequent speech token and the given reference speech token, a training loss component corresponding to the given subsequent speech token.

15. The electronic device of claim 13, wherein the training loss components are obtained with a plurality of speech features in the speech feature sequence being taken as the target speech feature respectively, and updating the model parameters of the speech encoding model based on the training loss components comprises:
determining a training loss based on a sum of the training loss components obtained for the plurality of speech features respectively; and
updating the model parameters of the speech encoding model based on the training loss.

16. The electronic device of claim 13, wherein the acts further comprise:
determining sequence length information of a speech token sequence corresponding to the speech feature sequence obtained with the speech encoding model; and
adjusting, based on the sequence length information, a sequence length of a reference speech token sequence corresponding to the speech feature sequence, the reference speech token being obtained with the discrete encoder, wherein the adjusted reference speech token sequence comprises the one or more reference speech tokens.

17. The electronic device of claim 10, wherein acquiring the speech feature sequence corresponding to the speech sample comprises:
determining a time-frequency representation corresponding to the speech sample, the time-frequency representation at least indicating an intensity of the speech sample over time at different frequencies; and
generating the speech feature sequence by down-sampling the time-frequency representation.

18. The electronic device of claim 10, wherein training the speech encoding model based on the one or more subsequent speech tokens comprises:
encoding, with a trained discrete encoder, the speech feature sequence to generate the one or more reference speech tokens respectively corresponding to the one or more subsequent speech features; and
training the speech encoding model based on a difference between the one or more subsequent speech tokens and the one or more reference speech tokens.

19. A non-transitory computer-readable storage medium having stored thereon a computer program executable by a processor to cause the processor to perform acts comprising:
acquiring a speech feature sequence corresponding to a speech sample, a speech feature in the speech feature sequence corresponding to a speech frame in the speech sample;
generating, for a target speech feature in the speech feature sequence, based on the target speech feature and one or more preceding speech features and according to a speech encoding model, one or more subsequent speech tokens respectively corresponding to one or more subsequent speech features, the one or more preceding speech features comprising speech features in the speech feature sequence that are prior to the target speech feature, and the one or more subsequent speech features comprising speech features in the speech feature sequence that are after the target speech feature; and
train the speech encoding model based on the one or more subsequent speech tokens.

20. The non-transitory computer-readable storage medium of claim 19, wherein generating the subsequent speech tokens respectively corresponding to the one or more subsequent speech features comprises:
generating, based on the target speech feature and the one or more preceding speech features and according to the speech encoding model, an encoded speech representation; and
generating, based on the encoded speech representation, the one or more subsequent speech tokens.
